(19) United States
(12) Patent Application Publication
(10) Pub. No.: US 2004/0203825 A1
(43) Pub. Date: Oct. 14, 2004

(54) Traffic control in cellular networks

(75) Inventors: Yoaz Daniel, Haifa (IL); Ran Asher Cohen, Omer (IL); Aharon Satt, Haifa (IL)

Correspondence Address: PATREA L. PABST, PABST PATENT GROUP LLP, 400 COLONY SQUARE, SUITE 1200, ATLANTA, GA, 30361, US

(73) Assignee: CellGlide Technologies Corp.

(21) Appl. No.: 10/222,286

(22) Filed: Aug. 16, 2002

(51) Int. Cl. H04Q 7/20

(52) U.S. Cl. 455/452.1; 455/449; 455/453

(57) ABSTRACT

Systems and methods, employed with data networks, for example, cellular networks, that provide dynamic awareness of: a) shared media or cell resources; and b) link-specific disturbances, are disclosed. The systems and methods (processes), and portions thereof, operate dynamically and “on the fly”. As a result, the systems and methods can control data flows (at various rates) through the shared media, allowing for transmissions, for example, of packets, at optimal bandwidths (bit rates), while maintaining existing protocol structures.

### TECHNICAL FIELD

The present invention is related directed to controlling packet traffic in data networks, and in particular, cellular networks.

### BACKGROUND

Cellular data networks, including wired and wireless networks, are currently widely and extensively used. Such networks include cellular mobile data networks, fixed wireless data networks, satellite networks, and networks formed from multiple connected wireless local area networks (wireless LANs). In each case, the cellular data networks include at least one shared media or cell.

FIG. 1 shows an exemplary Internet Protocol (IP) data network 20, formed of an Internet protocol (IP) host network 22, that can include a server or servers, a transport network 24, (e.g., cellular public land mobile data network) such as servers, switches, gateways, etc., and a shared media 26 or cells. The shared media 26 communicates with end user devices 28 (also referred to in this document as end users) over links 30. These end user devices 28 can be for example, personal computers (PCs), workstations or the like, laptop or palmtop computers, cellular telephones, personal digital assistants (PDAs) or other manned and unmanned devices able to receive and/or transmit IP data. The links 30 can be wired or wireless, and for example, can be a line or channel, such as a telephone line, a radio interface, or combinations thereof. These links 30 can also include buffers or other similar hardware and/or software, so as to be logical links. Data transfers through this network 20, as packets pass through the shared media 26, over the links 30 to the respective end user devices 28.

IP data networks, such as the data network 20, are typically governed by standard protocols, with data packet transfer governed by transport layer protocols. These transport layer protocols typically include User Datagram Protocol (UDP) and Transmission Control Protocol (TCP). In the data network 20, both the IP network 22 and end user devices 28 must employ a common transport layer protocol for data packet transfer to occur. However, transport layer protocols are extremely sensitive to disturbances in shared media 26, resulting in poor levels of service of data transfers to end user devices 28.

The shared media 26 typically experience disturbances caused by overflowing buffers, resulting in delays and packet loss, and bit-errors, caused by, for example, radio interference, also resulting in delays and packet loss and temporary stalled connections, due to factors such as cell handover (handoff) in cellular networks. Disturbances can also be caused by regulatory limitations on bandwidth and devices that are physically limited in bandwidth. Transmission bandwidth at the shared media can be unstable and dynamically changing. Moreover, transport layer protocols, that support transmissions through the shared media 26, are extremely sensitive to the aforementioned disturbances.

The transport layer protocols can be connectionless, such as with UDP. This UDP does not account for packet loss. Moreover, applications that use this protocol are typically sensitive to either delay accumulation of bit-rate instability or packet loss.

Alternately, these transport layer protocols can be connection oriented, such as TCP, that are of higher reliability than for example, UDP, allowing for partial compensation for disturbances. Applications that use this protocol are typically sensitive to delay accumulation, delay variations, bit-rate instability and loss of connections.

These transport layer protocols remain limited, as these protocols can not detect the nature of the network disturbance, and adapt to it, sometimes treating it as network congestion, or alternately, causing congestion by not recognizing available bandwidth. This results in transmissions of poor quality.

At present, two solutions are employed to handle the aforementioned problems associated with the protocols. These solutions are known as client-full and client-less.

The client-full solutions normally bypass the transport layer protocols by establishing an ad-hoc connection protocol between a specific end user device 28 and a specific server in the IP network 22. These solutions exhibit drawbacks in that in that they are manufacturer specific, and in many cases proprietary, and must be implemented specifically at each client and server for which they are applied. Additionally, by operating without regard to the shared media 26, these solutions still experience the problems associated with the shared media, that have been discussed above.

The client-less solutions are typically implemented at the protocol levels, avoiding some of the problems associated with the client-full solutions, for example manufacturer specific or proprietary adaptations are not required. These solutions are based on optimizing transport layer protocols. These solutions also exhibit drawbacks, in that like the transport layer protocols, they are unaware of the nature of the link or shared media disturbance, and therefore, can not fully or optimally compensate for it.

### SUMMARY

The present invention improves on the contemporary art by providing systems and methods (processes) that do not require custom adaptations of either the host server or client sides. The system and methods are such that it is there is a dynamic awareness of: a) shared media or cell resources; and b) link-specific disturbances. The systems and methods (processes), and portions thereof, operate dynamically and “on the fly”. As a result, the system and methods can control data flows (at various rates) through the shared media, allowing for transmissions, for example, of packets, at optimal bandwidths (bit rates), while maintaining existing protocol structures. The systems and methods (processes) disclosed herein work in compliance with TCP/IP standard protocols.

There is disclosed a method for controlling traffic in a network. This method includes measuring available bandwidth for at least one cell corresponding to at least one end user device, estimating the capacity of at least one link (typically, from the transport network to the end user device) associated with the at least one end user device, and allocating bandwidth to at least one flow associated with the at least one end user device.

Also disclosed is a programmable storage device (for example, a compact disc, magnetic or optical disc or the like) readable by a machine, tangibly embodying a program of instructions executable by a machine to perform method steps for managing traffic in a data network, the method steps selectively executed during the time when the program of instructions is executed on said the. These steps include, measuring available bandwidth for at least one cell corresponding to at least one end user device, estimating the capacity of at least one link (typically, from the transport network to the end user device) associated with the at least one end user device, and allocating bandwidth to at least one flow associated with the at least one end user device.

Also disclosed is a server for managing traffic in a data network. The server includes a processor programmed to: measure available bandwidth for at least one cell corresponding to at least one end user device, estimate the capacity of at least one link (typically, from the transport network to the end user device) associated with the at least one end user device, and allocate bandwidth to at least one flow associated with the at least one end user device.

There is disclosed a method for controlling traffic in a network. This method includes, estimating capacity of at least one link (typically, from the transport network to the end user device) associated with at least one end user device, estimating available bandwidth for at least one cell corresponding to at least one end user device, and allocating bandwidth to at least one flow associated with the at least one end user device.

There is also disclosed a server for controlling traffic in a network. The server includes a processor. The processor is programmed to, estimate the capacity of at least one link (typically, from the transport network to the end user device) associated with at least one end user device, estimate available bandwidth for at least one cell corresponding to at least one end user device, and allocate bandwidth to at least one flow associated with the at least one end user device.

There is also disclosed a programmable storage device readable by a machine, tangibly embodying a program of instructions executable by a machine to perform method steps for controlling traffic in a data network, the method steps selectively executed during the time when the program of instructions is executed on the machine. The steps include, estimating capacity of at least one link (typically, from the transport network to the end user device) associated with at least one end user device, estimating available bandwidth for at least one cell corresponding to at least one end user device, and allocating bandwidth to at least one flow associated with the at least one end user device.

There is disclosed a method for controlling the accumulated delay in a network. This method includes estimating packet travel data for at least one end user device and at least one cell corresponding thereto, and controlling bit rate associated with the at least one end user device and the at least one cell to limit the delay.

Also disclosed is a server for controlling the accumulated delay in a network. The server includes a processor programmed to: estimate packet travel data for at least one end user device and at least one cell corresponding thereto, and control bit rate associated with the at least one end user device and the at least one cell to limit the delay.

Also disclosed is a programmable storage device readable by a machine, tangibly embodying a program of instructions executable by a machine to perform method steps for controlling traffic in a data network, the method steps selectively executed during the time when the program of instructions is executed on the machine. These steps comprise, estimating packet travel data for at least one end user device and at least one cell corresponding thereto, and controlling bit rate associated with the at least one end user device and the at least one cell to limit the delay.

### BRIEF DESCRIPTION OF THE DRAWINGS

Attention is now directed to the attached drawings, wherein like reference numerals or characters indicate corresponding or like components. In the drawings:

FIG. 1 is a diagram of an exemplary contemporary network;

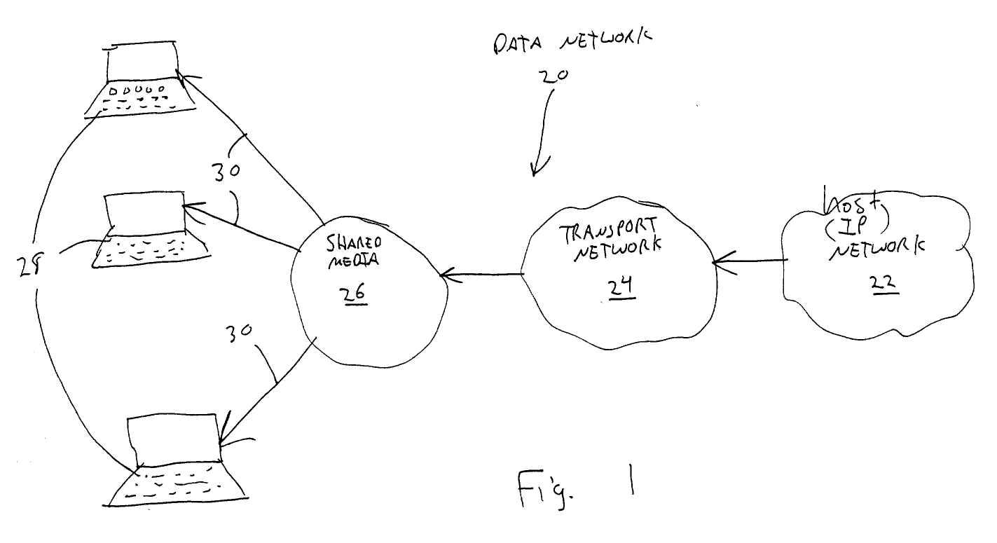

FIG. 2A is a diagram showing an exemplary network in use with an embodiment of the present invention;

FIG. 2B is a diagram detailing the buffer of FIG. 2A; and

FIG. 3 is a flow diagram detailing a process in accordance with an embodiment of the invention.

### DETAILED DESCRIPTION OF THE DRAWINGS

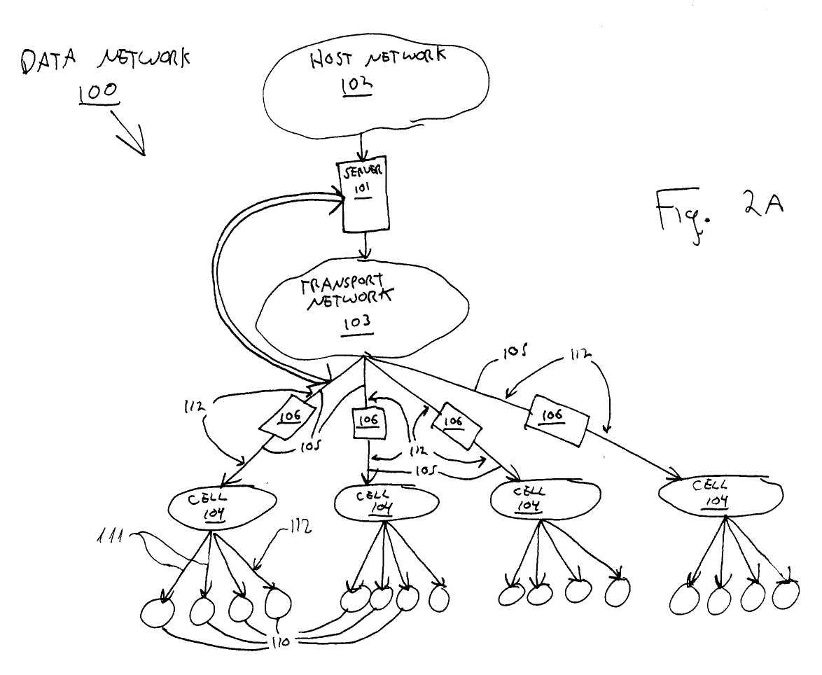

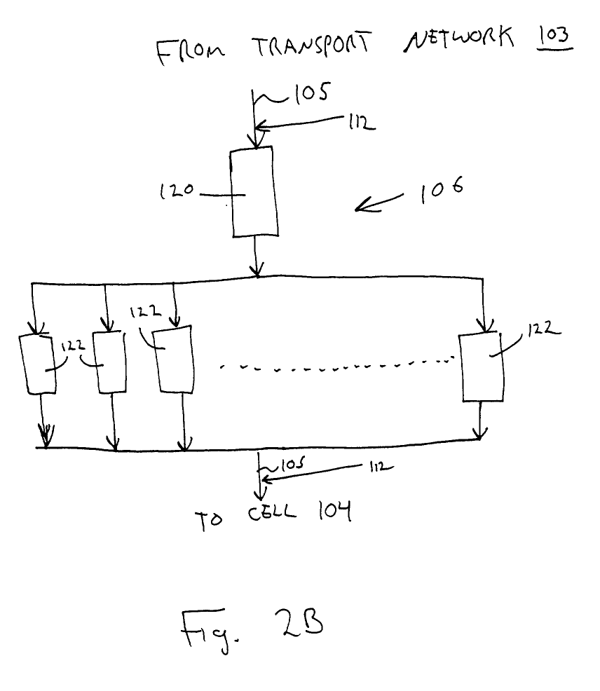

FIG. 2 shows an exemplary system 100 for performing the invention. The system 100 includes a server 101, manager gateway or the like that performs the invention, typically in software, hardware or combinations thereof.

The server 101 typically includes components (hardware, software or combinations thereof) such as storage media, processors (including microprocessors), network interface media (hardware, software or combinations thereof), queuing systems or devices (also referred to below as queues), and other hardware or software components. With respect to the queuing systems, they can be within the server 101 or remote from the server 101 provided that the server 101 controls these queuing systems. The server 101 is in communication with a host network 102, such as the Internet, Local Area Network (LAN) or any other IP network including at least one server, and wireless network (that includes cells), or the like.

The server 101 is also in communication with a transport network 103. This transport network can be for example, a cellular network. Alternately, the server 101 can reside within the transport network 103.

The server 101 communicates with shared access media or cells 104, over first channels 105 (wired or wireless), lines, pipes, etc. Buffer devices 106, for network buffering, typically sit within servers associated with the cells (such as BSC—Base Station Controllers) but can also sit within the transport network 103, the cells 104, or any other point where traffic to the cell flows through it. These buffers 106 can also be in any combination of separate buffers positioning within servers associated with the cells, the transport network 103 the cells 104, or any other point where traffic to the cell flows through it.

These buffers 106 may be formed of buffers 120 at the cell-level used for buffering the cell-level traffic, and buffers 122 at the user-level, corresponding to specific end user devices 110, used for buffering the user-level traffic, as shown in FIG. 2B. Alternately, these buffers 106 may be formed of buffers at the cell-level used for buffering the cell-level traffic, or buffers 122 at the user-level, corresponding to specific end user devices 110, used for buffering the user-level traffic, or combinations of both levels.

End user devices 110 (cell phones, PDA's, computers, etc. and manned or unmanned) (typically of the subscribers) are provided services from one or more shared access media or cells 104, typically over second channels 111 (wired or wireless), that for example may be air interfaces, such as radio channels. The first 105 and second 111 channels, together, form links 112 (the pathway over which a transmission(s) travel from the transport network 103 to the end user device 110, and vice versa), and will be referred to in this manner throughout this document.

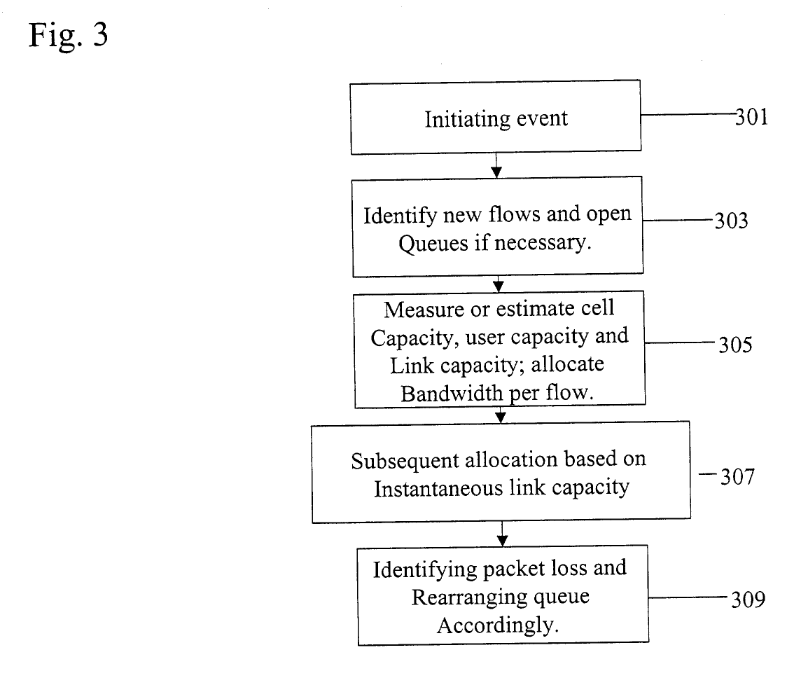

Turning also to FIG. 3, the processes performed by the server 102 are detailed in the form of a flow diagram. These processes may be performed by hardware, software or combinations thereof. The processes are performed dynamically, so as to be typically continuous (continuously), and “on the fly”. Additionally, the processes performed by the server 102, detailed below, in full or in part, can also be embodied in programmable storage devices (for example, compact discs or other discs including magnetic, optical, etc.) readable by a machine or the like, or other computer-usable storage medium, including magnetic, optical or semiconductor storage, or other source of electronic signals.

A process (method) begins at block 301, with an initiation, typically a triggering event. The triggering event can be for example, the arrival of a new flow, the termination of a flow, a timer event, or a default condition. As used herein, a flow is a sequence of one or more packets with common attributes, typically identified by the packet headers, for example, as having common source and common destination IP addresses and common source and common destination ports of either TCP or UDP. The default condition is the occurrence of a timer event, which can be for example, a timer of 50 milliseconds.

The initiation having occurred, the process moves to block 303, where new flows are identified and if necessary, a queue (typically, one per flow), for example, within the server 101, is opened. The queue is typically used to store and forward data packets from the server 101 to end user devices 110. By default, the queue is of the FIFO (first in first out) type.

The server 101 continuously maintains a listing of all existing flows. Each IP data packet arriving at the server 101 is identified, typically by its header. This header typically includes server and destination IP addresses and ports, that can be associated with the requisite flow.

Each flow is associated with a queue implemented at the server 101. While identifying each flow, the server 101 identifies the exact transport layer protocol governing the flow by its IP header, and checks whether or not it is connectionless. A queue is maintained for each existing flow, and upon the arrival of the first packet of a new flow, a new queue is established for this flow. Although a default position is typically to accept every new flow upon its arrival and establish a queue for it, other rules, as set by policies, may be applied. These rules may include prioritizing flows based on the user, the flow type, the flow source, etc. Accordingly, some flows may be discarded and not admitted passage into the cells 104 or shared media, to allow more resources to be available to other flows.

Throughout this process, the server 101 keeps a list of all existing flows destined for each end user device 110. Each end user device 110, having one or more active flows associated with it, is considered to be active.

In block 305, the server 101 measures the cell 104 available capacity (bandwidth), or the user 110 available capacity (bandwidth), or both. This measurement is typically done by monitoring (passive), or alternately querying (active), the respective cell 104 (the querying is represented by the arrow 130), or monitoring or querying the transport network 103, or monitoring the control signaling associated with the respective cell 104 that passed over the first channels 105, to obtain the temporary raw available capacity (bandwidth, bit-rate, resources) at the cell 104, for the requisite cell 104, or the temporary raw available capacity (bandwidth) for the user 110. The temporary raw available bandwidth may be given by the flow control signaling between the cell 104, or a server (controller) associated with the cell, and the transport network 103. The raw cell or user bandwidth measurements can be used as actual cell or user available bandwidth, respectively, without modification. Alternately, the server 101 can be programmed to calculate (estimate) the available cell capacity, or available user capacity, or both, by modifying the measurements, for example, by averaging them over time or use a median filter, over a sliding time window.

The process utilizes the available cell 104 bandwidth, or the available user bandwidths for the users 110 connected to the cell 104, or both, to allocate bandwidth (bit-rate) to all of the flows destined to a requisite end user device 110 connected to the cell 104. Every flow is allocated a portion of the link bandwidth, which establishes the transmission rate from the server 101 to the respective subscribers 110. By default, this allocation is done proportionally, so that each flow receives an equal share of the available cell capacity, in accordance with the following formula:

Fᵢ=C/E (1)

Where:

Fᵢ is the allocation for flow i, where i=1,2, . . . ,E;

E is the number of existing flows for the requisite cell; and

C is the requisite cell measured bandwidth as detailed in block 305.

The position of Formula (1), with equal resource sharing by the server 101, is the default position. Alternately, resources could be divided in different ways in accordance with rules and policies (for example, set by a system administrator), or any other preference system. For example, this allocation may be done by weighted fair queuing, priority queuing, or by applying a system of guaranteed or maximal bandwidth per flow. The resources may be divided among the flows destined to the cell 104, based on the available cell 104 capacity, or the available capacities for the users 110 linked to the cell 104, or both.

The process moves to block 307, where subsequent bandwidth allocations will be made. These subsequent allocations are based on the capacity of the link 112 at an instantaneous time. Link capacity is estimated by analyzing packet travel data, typically Round Trip Time (RTT) measurements, dynamically and “on the fly”, at any given time. The link 112 capacity estimation is done in addition to the user 110 capacity estimation. The user 110 capacity estimation may designate maximum bit-rate available for the user 110 based on flow control information, whereas the link 112 capacity may designate maximum bit-rate available for the user 110 based on RTT measurements.

Low RTT indicates link capacity that is higher than the actual bit-rate sent over the respective link, whereas high RTT measurements indicate lower link capacity. Above a certain reasonable RTT measurement, the link is considered temporarily disconnected, indicating the data transmission through this link is useless and harmful to other transmissions by overfilling buffers with insignificant packets.

RTT can be typically measured in two ways. These measurements are in accordance with the protocols being employed.

If a connection-oriented (opposite of connectionless) IP protocol is being used (as determined in block 303 as detailed above) in the requisite packet transmission, for example, a TCP, the server 101 utilizes internal protocol RTT measurements. With a reliable connection provided by the connection-oriented protocol, the server 101 is acknowledged by the requisite end user device 110, when it receives packets. The server 101 keeps track of the time between the sending of the packet(s) and the receipt of the acknowledgment.

Alternately, if a connectionless protocol is being used (as determined at block 303, as detailed above), the server 101 transmits a new IP packet to the requisite end user device 110. This IP packet induces a response from the end-user device 110. The server 101 measures the time between the transmission of this packet and the response from the end user device 110. For example, this new IP packet can be a standard Internet Control Massage Protocol (ICMP) echo request.

The exemplary ICMP packets are sent by the server 101, on top of the traffic that flows between the server 101 and the requisite end user device 110. The host network 102 is not aware of the ICMP packets.

Alternately, the process associated with the connectionless protocol can be used for connection oriented protocols as well. In particular, this occurs when the protocol internal RTT measurements are absent or inaccurate. Throughout this process step(s), the server 101 keeps track of all RTT measurements relating to any of the end user devices 110 that are active.

To insure against inactivity, the server 101 maintains a time out value, with a default. This default is, for example, 10 seconds, to accommodate the system when the above described acknowledgment or a response has not been received at the server 101. Upon expiration of the default time period, here for example, 10 seconds, the server 101 retransmits the requisite data unit or reply-inducing packet, and sets the current measurement of RTT to the default value.

Alternately, other time-out mechanisms can be used. These mechanisms include exponential back off, where the time out for each end user device 110 is doubled every time a new time out occurs.

The process continues with subsequent bandwidth allocations based on RTT measurements as follows:

RTTᵢ≦D₀ (2)

where,

RTTᵢ is the delay of the end user device I; and

D₀ is a preconfigured constant, with default of 2 seconds.

If relation (2) is true (it holds) then, the link does not require bandwidth adjustment to the allocation previously made in block 305 (detailed above). This can be done, for example, according to the following formula:

Rnewᵢ=Rᵢ (3)

where,

Rnewᵢ is the new rate to be calculated for user I; and

Ri is the rate previously allocated for user I in block 305 (detailed above), this rate allocated for a user, here for example, user I, is the sum of allocations made in block 305 for each of the flows destined for the particular user, here user I.

If relation (2) does not hold, the process applies the following relation:

RTTᵢ<Dᵢ (4)

where,

D₁ is a preconfigured content with a value of 10 seconds.

If relation (4) is true (holds), the bandwidth allocation from block 305 must be adjusted. The increased RTT measurement indicates that a buffer or buffers along the link 112 are being filled. This indicates that the capacity of the link 112 has diminished. In such a case, the allocation is modified so as to fit the new link capacity. This can be done for example, by the following formula:

Rnewᵢ=Rᵢ(RTTᵢ−D₀)/RTTᵢ (5)

where all parameters are defined above.

Alternatively, if relation (4) does not hold (is false), then data transmission to the requisite end user device 110 is paused, as the link 112 is considered to be temporarily disconnected. To avoid inactivity, a new IP packet is transmitted to the requisite end user device 110, to induce a response, as detailed above. This transmission is by default, and typically occurs following a time out expiration.

Pausing data transmission to the requisite end user device 110 is done by rapidly reducing bandwidth allocation to the requisite end user device 110 over the link 112. This could be done, for example, by the following formula:

Rnew_{d}=0 (7)

where,

Rnew_{d} is the new rate to be allocated for a end user device for which relation (4) does not hold, here for example, the end user device d.

The process continues by checking (querying) whether the above described subsequent allocations resulted in cell bandwidth being fully utilized. This is typically done by checking spare bandwidth at the cell, where spare bandwidth is bandwidth not allocated as described above.

This spare bandwidth can be calculated for example, by the following formula:

S=C−Σ_{k=1 to N}Rnewₖ (8)

where,

S is the spare bandwidth to be calculated,

C is the cell bandwidth as obtained in block 305, and

N is the number of active users of the cell as obtained from block 305 above.

To avoid underutilization of cell bandwidth, the spare bandwidth is divided for all end user devices 110, whose respective links can use additional bandwidth efficiently. This can be done for example, according to the following formula:

Rnewₖ=Rnewₖ+S/L (9)

where,

Rnewₖ is the new rate to be calculated for each user K, where K is a user for which relation (2) above holds (is true), and

L is the number of active users for which relation (2) above holds.

A bandwidth reallocation, to divide bandwith allocated for an end user device 110 to all active flows of that end user device 110, is now made, according to the following formula:

Fⱼ=Rnewᵢ/M (10)

where,

M is the number of flows;

Fⱼ is the rate to be calculated for each of the flows of user I, where j=1,2, . . . M.

Alternately, the process steps of block 307, can be performed by taking into account the change in current RTT measurements with respect to previous RTT measurements, to accommodate trends in the changes in RTT measurements, rather then specific RTT values. If this method is employed, then, when an increase in RTT is detected, bandwidth allocations are reduced, and when a decrease in RTT measurements is detected, bandwidth allocations are increased. These increases and decreases to allocations are by default and linearly proportional to the respective decreases and increases in RTT measurements.

Moving to block 309, steps are taken to compensate for packet loss. These steps are taken if compensation is possible.

Packets may have become “lost” due to factors such as radio interference, overfull buffers, network bit-errors, etc. Compensation for packet loss is only possible where connection oriented flows are concerned, since only in these flows are data units are being acknowledged.

For any connection oriented flow, data units normally arrive in sequence. Here, for example, the server 101 keeps track of the sequence number of the requisite data unit. For example, sequence numbers are obtained by reading these numbers from standard TCP packet headers. These sequence numbers are integral parts of a connection oriented IP flow, since they enable both server and client sides to identify the data being transferred.

The process of compensation occurs by first analyzing whether or not a packet or packets is “lost”. A packet is considered “lost” when, 1) the end user device 110 has not acknowledged the packet or packets for a specified time out period, in accordance with that detailed above, or 2) an acknowledgment for a packet with a higher sequence number arrived before a packet with a lower sequence number was expected to arrive (but did not).

In the situation where packet loss occurred due to timing out, the lost packet(s) is brought to the beginning of the flow's requisite queue (within the server 101). Transmission rate from this queue is typically reduced as detailed in block 307 above.

In the situation where the higher sequenced packet arrived before the lower sequenced packet was expected to arrive, the lost packet is brought to the beginning of the queue (within the server 101) of the requisite flow. Transmission rate from this queue is typically allocated according to cell capacity as detailed in block 305 above, or enlarged as detailed in block 307 above.

In both of the aforementioned retransmissions of the “lost” packet(s), the processes performed mimic the connection oriented IP Protocols, such as TCP. In this way, both the host network 102 and end user devices 110 do not need to be physically or otherwise modified (with hardware, software or combinations thereof), as the process complies with standard protocols.

The process described above controls the bandwidth of flows based on measurements of RTT and results in controlling RTT values. This process forms a method for controlling and limiting the delay accumulated in the buffers 106, since this delay, as measured in units of time (e.g., seconds) is bounded by the respective RTT. Accordingly, the above detailed process supports network buffering delay control, that is necessary for delay sensitive traffic.

The above described process of blocks 301, 303, 305, 307 and 309 can be repeated as long as desired (until, for example, terminated by a system administrator, preprogrammed rules, end of flows, etc.).

In another embodiment of the invention, measurements of available cell capacity (bandwidth), as detailed above in block 305 of FIG. 3, may not be available. In this alternate embodiment the invention can be performed as detailed above, except for the following process, which estimates available cell bandwidth dynamically and on the fly.

The process of estimating available cell capacity begins with a default estimation, the default being, for example, 40 kilo bits per second.

This process continues by querying RTT measurements as detailed above, in block 307 (FIG. 3), and analyzing these measurements. This analysis is aimed at determining if cell capacity had increased or decreased from prior cell bandwidth estimations. This determination could be done, for example, by applying the following relation:

T₁>Σ_{i=1,2, . . . N}RTTᵢ/N (11)

Where,

T₁ is a default value, with a default of, for example, 6 seconds;

RTTᵢ is the measured RTT for user i, as detailed above, in block 307 (FIG. 3); and

N is the number of active users in the cell, as determined in block 305 (FIG. 3) and above.

Where relation 11 users arithmetic mean, this is exemplary only, for other filtering methods might be used, such as geometric averaging, median filtering, exponential mean taken over a sliding time window, etc.

If relation (11) holds (is true) than the analysis is that no delays had occurred for the generality of users, and hence the estimation of cell bandwidth could be increased, as the cell has extra capacity. This could be done, for example, according to the following formula:

C_{new}=min(a·C_{old},Cₘₐₓ) (12)

where,

C_{new} is the new cell estimation to be calculated;

C_{old} is the previously existing cell bandwidth estimation;

Cₘₐₓ is the configured maximal cell capacity, the default for which being 100 kilo bits per second; and

a is a constant used for increasing cell bandwidth estimation, with a default of 1.1.

If relation (11) does not hold (is false), than it is concluded that delays indicate a decrease in cell bandwidth capacity, so that previous estimation has to be lowered. This could be done, for example, according to the following formula:

C_{new}=max(b·C_{old},Cₘᵢₙ) (13)

Where,

Cₘᵢₙ is the configured minimal cell bandwidth, the default for which being 0 kilo bits per second; and

b is a constant used for decreasing cell bandwidth, the default for which being 0.8.

After concluding an estimation of cell bandwidth as described above, the process proceeds with blocks 307 and 309 (FIG. 3) as detailed above.

An additional embodiment of the invention employs a further rate control mechanism to adapt to situations where certain flows destined for a particular end user device have a rate control mechanism, external to the transport network 103. For example, in connection oriented flows, such as TCP, the rate of transmission to the end user device 28 might be governed by acknowledgements received from the end user device. In this example, the host network 102 can reduce rate drastically whenever acknowledgments are overdue or missing.

Here, for example, external rate control mechanisms are redundant, since flow rate allocations, as detailed above, are now optimal to satisfy link, cell and user capacities, as well as administrator policies.

Accordingly, in this embodiment, the server 101 mimics or proxies the requisite end user devices 110 towards the host network 102, so that a server or other element in the host network 102 experiences good link conditions. Good link conditions refer to link conditions that are not affected by delays and/or packet losses due to buffering and interference on the cellular side (from the transport network 103 to the end user devices 110) of the network 20. This may be done, for example, by acknowledging the host network for each data packet, or another appropriate data unit, such as transmission window in TCP, arriving at the server 101. These acknowledgments can be sent according to either of the following methods: a. immediately upon receipt of the packets from the host server (or the like) in the host network 102, up to a certain amount of data accumulated in the server 101 and not yet received by the requisite end user device 110. This ensures that the host network 102 sends data at its optimal or maximal rate, so that the queues of the server 101 always have packets to send to the end users; and b. acknowledgements can be sent at the rate of transmission from the server 101 to the end user device 110, so that, for example, for every packet sent to the requisite end user device 110, the server 101 also sends an acknowledgment to the server of the host network 102. This method enables informing the server within the host network 102 of the actual rate the requisite end user device 110 can handle.

Any of the above methods can be used, where method b is the default.

This alternate embodiment enables overriding inapplicable or sub optimal bandwidth (bit-rate) allocations or adaptations, made by the host network 102, end user devices 110, protocols therein, or combinations thereof.

The methods and apparatus disclosed herein have been described with exemplary reference to specific hardware and/or software. The methods have been described as exemplary, whereby specific steps and their order can be omitted and/or changed by persons of ordinary skill in the art to reduce embodiments of the present invention to practice without undue experimentation. The methods and apparatus have been described in a manner sufficient to enable persons of ordinary skill in the art to readily adapt other commercially available hardware and software as may be needed to reduce any of the embodiments of the present invention to practice without undue experimentation and using conventional techniques.

While preferred embodiments of the present invention have been described, so as to enable one of skill in the art to practice the present invention, the preceding description is intended to be exemplary only. It should not be used to limit the scope of the invention, which should be determined by reference to the following claims.

What is claimed is:

1. A method for controlling traffic in a network comprising:
measuring available bandwidth for at least one cell corresponding to at least one end user device;
estimating the capacity of at least one link associated with said at least one end user device; and
allocating bandwidth to at least one flow associated with said at least one end user device.

2. The method of claim 1, wherein said measuring available bandwidth for at least one cell includes measuring the capacity of said at least one cell.

3. The method of claim 1, wherein said measuring available bandwidth for at least one cell includes measuring the capacity of at least one end user device associated with said at least one cell.

4. The method of claim 1, wherein said measuring available bandwidth for at least one cell includes measuring the capacity of said at least one cell and measuring the capacity of at least one end user device associated with said at least one cell.

5. The method of claim 2, wherein said measuring the capacity of at least one cell includes:
monitoring flow control signaling associated with said at least one cell.

6. The method of claim 5, wherein said measuring the capacity of said at least one cell additionally includes: modifying said monitored flow control signaling through filtering.

7. The method of claim 3, wherein said measuring the capacity of at least one end user device includes: monitoring flow control signaling associated with said at least one end user device.

8. The method of claim 7, wherein said measuring the capacity of said at least one end user device additionally includes: modifying said monitored flow control signaling through filtering.

9. The method of claim 1, wherein said step of estimating capacity of said at least one link includes measuring packet travel data associated with said at least one end user device.

10. The method of claim 9, wherein said measuring packet travel data associated with said at least one end user device includes measuring round trip time associated with said at least one end user device.

11. The method of claim 1, wherein said allocating bandwidth to at least one flow associated with said at least one end user device includes:
controlling the bandwidths of said at least one flow associated with said at least one end user according to said estimated link capacity associated with said at least one end user device.

12. The method of claim 9, wherein said allocating bandwidth to at least one flow associated with said at least one end user device includes:
controlling the bandwidths of said at least one flow associated with said at least one end user according to said packet travel data associated with said at least one end user device.

13. The method of claim 1, wherein said measuring said available bandwidth for at least one cell includes measuring on said at least one link.

14. A programmable storage device readable by a machine, tangibly embodying a program of instructions executable by a machine to perform method steps for managing traffic in a data network, said method steps selectively executed during the time when said program of instructions is executed on said machine, comprising:
measuring available bandwidth for at least one cell corresponding to at least one end user device;
estimating the capacity of at least one link associated with said at least one end user device; and
allocating bandwidth to at least one flow associated with said at least one end user device.

15. A server for managing traffic in a data network comprising:
a processor programmed to:
measure available bandwidth for at least one cell corresponding to at least one end user device;
estimate the capacity of at least one link associated with said at least one end user device; and
allocate bandwidth to at least one flow associated with said at least one end user device.

16. The server of claim 15, wherein said processor programmed to measure available bandwidth for at least one cell is additionally programmed to measure the capacity of said at least one cell.

17. The server of claim 15, wherein said processor programmed to measure available bandwidth for at least one cell is additionally programmed to measure the capacity of at least one end user device associated with said at least one cell.

18. The server of claim 15, wherein said processor programmed to measure available bandwidth for at least one cell is additionally programmed to measure the capacity of said at least one cell and measuring the capacity of at least one end user device associated with said at least one cell.

19. The server of claim 16, wherein said processor programmed to measure the capacity of at least one cell includes:
monitoring flow control signaling associated with said at least one cell.

20. The server of claim 17, wherein said processor programmed to measure the capacity of at least one end user device includes: monitoring flow control signaling associated with said at least one end user device.

21. The server of claim 15, wherein said processor programmed to estimate capacity of said at least one link is additionally programmed to measure packet travel data associated with said at least one end user device.

22. The server of claim 21, wherein said measuring packet travel data associated with said at least one end user device includes measuring round trip time associated with said at least one end user device.

23. The server of claim 15, wherein said processor programmed to allocate bandwidth to at least one flow associated with said at least one end user device is additionally programmed to:
control the bandwidths of said at least one flow associated with said at least one end user according to said estimated link capacity associated with said at least one end user device.

24. A method for controlling traffic in a network comprising:
estimating capacity of at least one link associated with at least one end user device;
estimating available bandwidth for at least one cell corresponding to at least one end user device; and
allocating bandwidth to at least one flow associated with said at least one end user device.

25. The method of claim 24, wherein said estimating available bandwidth for at least one cell includes determining if a previously estimated available bandwidth of said at least one cell has changed, and updating said estimated available bandwidth.

26. The method of claim 25, wherein said estimating available bandwidth for at least one cell includes:
determining if a previously estimated available bandwidth has changed based on the packet travel data associated with said at least one end user device corresponding with said at least one cell, and updating said estimated available bandwidth.

27. The method of claim 24, wherein said allocating bandwidth to at least one flow associated with said at least one end user device includes:
controlling the bandwidths of said at least one flow associated with said at least one end user according to said estimated link capacity associated with said at least one end user device.

28. The method of claim 24, wherein said allocating bandwidth to at least one flow associated with said at least one end user device includes:
controlling the bandwidths of said at least one flow associated with said at least one end user according to said packet travel data associated with said at least one end user device.

29. A server for controlling traffic in a network comprising:
a processor programmed to:
estimate the capacity of at least one link associated with at least one end user device;
estimate available bandwidth for at least one cell corresponding to at least one end user device; and
allocate bandwidth to at least one flow associated with said at least one end user device.

30. The server of claim 29, wherein said processor programmed to estimate said available bandwidth for at least one cell, is additionally programmed to:
determine if a previously estimated available bandwidth of said at least one cell has changed, and update said estimated available bandwidth.

31. The server of claim 29, wherein said processor programmed to estimate said available bandwidth for at least one cell, is additionally programmed to:
determine if a previously estimated available bandwidth has changed based on the packet travel data associated with said at least one end user device corresponding with said at least one cell, and
update said estimated available bandwidth.

32. The server of claim 29, wherein said processor programmed to allocate bandwidth to at least one flow associated with said at least one end user device, is additionally programmed to:
control the bandwidths of said at least one flow associated with said at least one end user according to said estimated link capacity associated with said at least one end user device.

33. The server of claim 29, wherein said processor programmed to allocate bandwidth to at least one flow associated with said at least one end user device, is additionally programmed to:
control the bandwidths of said at least one flow associated with said at least one end user according to said packet travel data associated with said at least one end user device.

34. A programmable storage device readable by a machine, tangibly embodying a program of instructions executable by a machine to perform method steps for controlling traffic in a data network, said method steps selectively executed during the time when said program of instructions is executed on said machine, comprising:
estimating capacity of at least one link associated with at least one end user device;
estimating available bandwidth for at least one cell corresponding to at least one end user device; and
allocating bandwidth to at least one flow associated with said at least one end user device.

35. A method for controlling the accumulated delay in a network comprising: estimating packet travel data for at least one end user device and at least one cell corresponding thereto; and controlling bit rate associated with said at least one end user device and said at least one cell to limit said delay.

36. The method of claim 35, wherein said estimating packet travel data includes estimating round trip times (RTT) for said at least end user device.

37. The method of claim 36, wherein said estimating RTT includes sending at least one Internet Control Message Protocol (ICMP) packet on top of downstream user data to said at least one end user device. Internet control message protocol.

38. The method of claim 35, wherein said controlling bit-rate includes controlling the bit rate of at least one flow associated with said at least one end user device.

39. A server for controlling the accumulated delay in a network comprising: a processor programmed to:
estimate packet travel data for at least one end user device and at least one cell corresponding thereto; and
control bit rate associated with said at least one end user device and said at least one cell to limit said delay.

40. The server of claim 39, wherein said processor programmed to estimate packet travel data is additionally programmed to: estimate round trip times (RTT) for said at least end user device.

41. The server of claim 40, wherein said processor programmed to estimate RTT, is additionally programmed to send at least one Internet Control Message Protocol (ICMP) packet on top of downstream user data to said at least one end user device.

42. The server of claim 39, wherein said processor programmed to control bit rate, is additionally programmed to control the bit rate of at least one flow associated with said at least one end user device.

43. A programmable storage device readable by a machine, tangibly embodying a program of instructions executable by a machine to perform method steps for controlling traffic in a data network, said method steps selectively executed during the time when said program of instructions is executed on said machine, comprising:
estimating packet travel data for at least one end user device and at least one cell corresponding thereto; and
controlling bit rate associated with said at least one end user device and said at least one cell to limit said delay.
